(19) United States
(12) Patent Application Publication
(10) Pub. No.: US 2018/0019870 A1
(43) Pub. Date: Jan. 18, 2018

(54) DEVICE TO LIMIT ACCESS TO STORAGE TO AUTHENTICATED ACTORS ONLY

(71) Applicant: QUALCOMM Incorporated, San Diego, CA (US)

(72) Inventors: Mauro Scagnol, Cambridge (GB); Nicolas Graube, Cambridge (GB)

(21) Appl. No.: 15/212,089

(22) Filed: Jul. 15, 2016

(51) Int. Cl. H04L 9/08; H04L 9/06; H04L 9/32

(52) U.S. Cl. CPC H04L 9/0861; H04L 9/3247; H04L 9/0643; H04L 2209/16

(57) ABSTRACT

Aspects may relate to a device to provide access to storage to authenticated actors only. The device may comprise a processor and a storage. The processor may be coupled to the storage and may be configured to: obtain a nonce; obtain an actor signed hash for an actor; and apply a key derivation function utilizing the actor signed hash and the nonce as inputs to create an actor specific key encapsulating key (KEK). The processor may command the storage of an actor specific storage key, wrapped using the actor specific KEK. Further, the processor may use the actor specific KEK to unwrap actor specific keys used to access storage.

### BACKGROUND

### Field

The present invention relates to a device that limits access to data storage to authenticated actors only.

### Relevant Background

In today's computer-based world, the secure storage of data by computing devices and the authentication of authorized data owners to retrieve their data from devices, as opposed to unauthorized ones, has become of increasing concern. This is especially the case when a device may manage the storage of data for multiple data owners; data owners could be, for example, applications executing on a processor on the very same device where data is stored or other software or hardware instances (such as applications executing on other devices, hardware components inside a device or entire devices seen as a single entity) locally or remotely accessing the device where data is stored through some communication channel and requesting access to the stored data. To keep the concept of data owner as generic as possible, in this specification, the term “actor” is used instead. In order to be secure, data stored on storage devices, such as, easily accessible non-volatile memory (NVM), needs to be encrypted and integrity verified; also, each actor should only be able to access their own data: data leaks between actors sharing the same storage should be prevented by design.

Further, data should only be released to the authorized actor, and only after the actor has been authenticated through the result of an objective measurement, performed in a controlled and trusted environment, so that if the integrity of the actor has been compromised, the corrupted or hacked code cannot be used to leak sensitive stored data.

Moreover, actors such as, for example, applications executing on the device where data is stored, should be able to be securely updated locally or Over the Air (OTA), in such a way that the updated actor can still access the data, originally recorded by a previous version of the actor.

### SUMMARY

Aspects may relate to a device to provide access to storage to authenticated actors only. The device may comprise a processor and a storage. The processor may be coupled to the storage and may be configured to: obtain a nonce; obtain an actor signed hash for an actor; and apply a key derivation function utilizing the actor signed hash and the nonce as inputs to create an actor specific key encapsulating key (KEK). The processor may command the storage of an actor specific storage key, wrapped using the actor specific KEK. Further, the processor may use the actor specific KEK to unwrap actor specific keys used to access storage.

### BRIEF DESCRIPTION OF THE DRAWINGS

FIG. 1 is a diagram of a system in which embodiments may be practiced.

FIG. 2 is a diagram of an example of different actors utilizing a Root of Trust (RoT) to implement embodiments.

FIG. 3 is a diagram of a process for adding a new actor.

FIG. 4 is a diagram of a process to allow an actor to access stored encrypted data.

FIG. 5 is a diagram of a process to update an actor's code.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the terms “device”, “computing device”, or “computing system”, may be used interchangeably and may refer to any form of computing device including but not limited to laptop computers, personal computers, tablets, smartphones, system-on-chip (SoC), televisions, home appliances, cellular telephones, watches, wearable devices, Internet of Things (IoT) devices, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, desktop computers, servers, or any type of computing device or data processing apparatus.

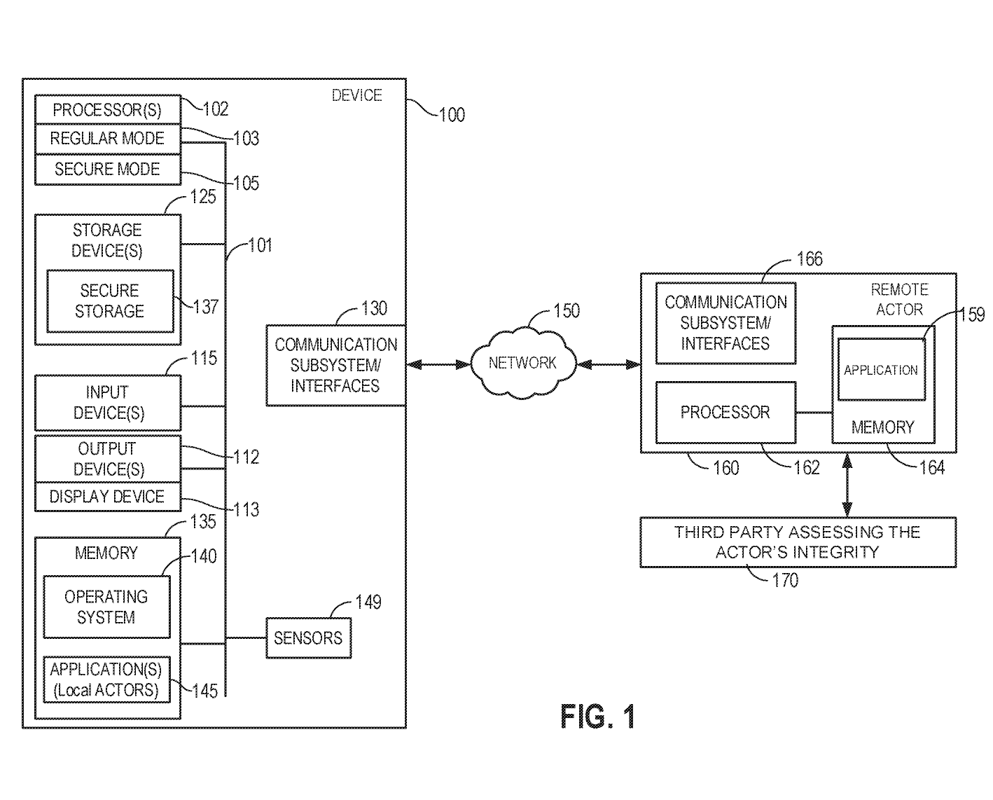

With reference to FIG. 1, as an example, device 100 may be in communication with one or more actors 160, respectively, via a network 150 (e.g., wireless, wired, or a combination thereof). As will be described, each actor 160 may be a particular entity (e.g., a network company, utility company, commercial company, government institution, i.e., any entity) that utilizes device 100 by implementing a particular application 145 on device 100 to locally operate some sort particular function utilizing the device's resources. Each actor 160 is therefore a data owner on device 100. Another actor could be, for example, a fully autonomous application 145 executing on device 100 as hereafter described. As will be described, by utilizing a storage 137, having a storage area separated for each actor 160 or 145, each actor 160 or 145 may separately operate an application on the device with a separate storage area utilizing the resources of the device providing enhanced security. As will be described hereafter, storage 137 may be referred to as secure storage 137.

As an example, device 100 may comprise hardware elements that can be electrically coupled via a bus 101 (or may otherwise be in communication, as appropriate). The hardware elements may include one or more processors 102, including without limitation one or more general-purpose processors and/or one or more special-purpose processors (such as secure processors, cryptoprocessors, digital signal processing chips, graphics acceleration processors, and/or the like); one or more input devices 115 (e.g., keyboard, keypad, touchscreen, buttons, microphone, camera, etc.); and one or more output devices 112—such as a display device (e.g., a screen) 113, speaker, sound device, etc. Additionally, device 100 may include a wide variety of sensors 149. Sensors may include: a clock, an ambient light sensor (ALS), a biometric sensor, an accelerometer, a gyroscope, a magnetometer, an orientation sensor, a fingerprint sensor, a weather sensor (e.g., temperature, wind, humidity, barometric pressure, etc.), a Global Positioning Sensor (GPS), an infrared (IR) sensor, a proximity sensor, near field communication (NFC) sensor, a microphone, a camera, or any type of sensor.

In one embodiment, processor 102 may operate in a regular mode 103 and/or a secure mode 105. In one embodiment, processor 102 may itself be a secure processor and/or operate in the secure mode 105 to create a trusted execution environment to implement a Root of Trust (RoT) to implement functions, as will be hereafter described.

Device 100 may further include (and/or be in communication with) one or more non-transitory storage devices or non-transitory memories 125, which can comprise, without limitation, local and/or network accessible storage, and/or can include, without limitation, a disk drive, a drive array, an optical storage device, flash memory, solid-state storage device such as appropriate types of random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

Device 100 may also include communication subsystems and/or interfaces 130, which may include without limitation a modem, a network card (wireless or wired), a wireless communication device and/or chipset (such as a Bluetooth device, an 802.11 device, a Wi-Fi device, a WiMax device, cellular communication devices, etc.), and/or the like. The communication subsystems and/or interfaces 130 may permit data to be exchanged with other actors 160 through an appropriate network 150 (wireless and/or wired).

In some embodiments, device 100 may further comprise a working memory 135, which can include a RAM or ROM device, as described above. Device 100 may include firmware elements, software elements, shown as being currently located within the working memory 135, including an operating system 140, applications 145, device drivers, executable libraries, and/or other code. In one embodiment, an application may be designed to implement methods, and/or configure systems, to implement embodiments, as described herein. Merely by way of example, one or more procedures described with respect to the method(s) discussed below may be implemented as code and/or instructions executable by a device (and/or a processor within a device); in an aspect, then, such code and/or instructions can be used to configure and/or adapt a device 100 to perform one or more operations in accordance with the described methods, according to embodiments described herein.

A set of these instructions and/or code may be stored on a non-transitory computer-readable storage medium, such as the storage device(s) 125, described above, and/or within storage memory 137, or other memory 135 locations. In some cases, the storage medium might be incorporated within a computer system, such as device 100. In other embodiments, the storage medium might be separate from the devices (e.g., a removable medium, such as a compact disc), and/or provided in an installation package, such that the storage medium can be used to program, configure, and/or adapt a device with the instructions/code stored thereon. These instructions might take the form of executable code, which is executable by device 100 and/or might take the form of source and/or installable code, which, upon compilation and/or installation on device 100 (e.g., using any of a variety of generally available compilers, installation programs, compression/decompression utilities, etc.), then takes the form of executable code.

Further, device 100 may include a memory, such as, a storage 137, to allow for the storage of actor specific encrypted data and actor specific storage keys to implement embodiments to be hereafter described. Storage 137 may be a flash memory or EEPROM. Storage may also be implemented using part or all the non-secure storage device(s) 125, provided it is encrypted and integrity checked using methods based on keys that may be actor 160 or 145 specific. However, storage 137 may be any type of suitable non-volatile memory often utilized for security purposes. Although storage 137 may be any type of suitable non-volatile memory, because of the encryption and integrity check methods based on keys, storage 137 may hereafter be referred to as secure storage 137.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein. Further, connection to other devices such as network input/output devices may be employed.

As previously described, device 100 may be any type of device, computer, smartphone, tablet, cellular telephone, watch, wearable device, Internet of Things (IoT) device, or any type of computing device that can communicate with actors 160 via a wired and/or wireless network 150. Further, as has been previously described, device 100 may be in communication via interface 130 through network 150 to an actor 160. It should be appreciated that actor 160 may be a device having at least a processor 162, a memory 164 with one or more applications 159, an interface/communication subsystem 166, as well as other hardware and software components, to implement operations.

For example, actor 160 may be a particular entity (e.g., a network company, utility company, commercial company, government institution, i.e., any entity) that utilizes device 100 by implementing a particular application 145 on device 100 to operate some sort particular function utilizing the device's resources. Each actor 160 is therefore a data owner on device 100. As will be described, by utilizing a secure storage 137, having a secure storage area separated for each actor 160, each actor 160 may separately operate an application on the device with a separate secure storage area utilizing the resources of the device providing enhanced security. It should be appreciated that device 100 and actor(s) 160 may be in communication through network 150 in a wireless, wired, or combination of wireless/wired fashion.

Aspects to be described hereafter may relate to a method performed by device 100 for the creation of actor specific secure storage keys. Further, aspects to be described hereafter may relate to a method performed by device 100 to allow access to secure storage 137 by an actor 160 or 145 only if the actor has been authenticated through a successful measurement of its integrity and the actor may only be granted access to a particular region of secure storage 137 designated for that particular actor 160 or 145. Moreover, aspects to be described hereafter may relate to a method performed by device 100 to allow access to secure storage 137 for a specific actor 160 or 145 after updates of the actor.

As will be described, aspects may relate to methods that are applicable to a chipset (e.g., a SoC) of a device 100 capable of supporting a multi-tenant embedded execution environment. This multi-tenant embedded execution environment may be managed by a deeply embedded Root of Trust (RoT) which may operate as a hardware assisted firmware solution that provides a framework for enabling secure execution of multiple different actor applications. During their execution, actor applications 145 (in the framework itself) may share chip resources, such as, volatile or non-volatile memory (e.g., memory 135 and/or secure storage 137), as well as other peripheral devices (e.g., specialized processors 102, sensors 149, input devices 115, output devices 112, communication interfaces 130, etc.), through arbitration controlled by the RoT, such that access to the shared resources is disciplined, while the integrity and confidentiality of each actor's code, actor's programs/applications, and actor's data is guaranteed.

As will be described, aspects may relate to implementations in which a SoC of a device 100 may be executing multiple applications 145 and some of them can be executed for multiple different actors 160. This may be useful for IoT devices that are unsuitable for rich mobile operating systems and have constrained operating capabilities and may be low cost. Further, these types of devices may support various orthogonal aspects such as communications, signal processing, etc. These various types of software/program components may be implemented as concurrently executing services or applications hereinafter referred to as actors 160 or 145. Actors 160 may be connected via a wireless or wired network 150, as previously described. As has been described, this type of multi-tenant implementation may have different actors 160 or 145 that wish to have their code and data strongly separated from one another. Further, aspects to be described for these types of implementations (especially SoC implementations) are beneficial in strongly supporting a lightweight root of trust (RoT) overseeing resource sharing and in particular: 1) a RoT that provides each actor with secure storage space separate from other actors; 2) a RoT that checks the integrity of each actor; and 3) a RoT that allows each actor to independently over the cable (OTC) or over the air (OTA) to be updateable and still maintain access to data in the dedicated storage space.

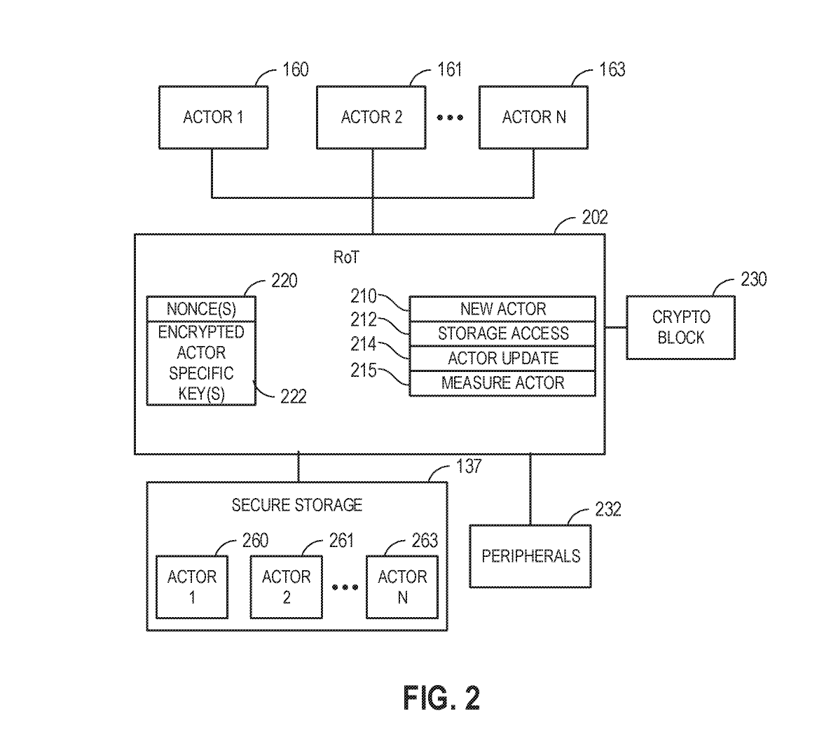

With additional reference to FIG. 2, as an example, three different actors (e.g. Actor 1 160, Actor 2 161, Actor N 163) may utilize a Root of Trust (RoT 202) to implement embodiments to be described herein. RoT 202 may be a firmware application and may be implemented by processor 102. In one embodiment, processor 102 may operate in a secure mode 105 to provide a trusted execution environment to implement RoT 202. RoT 202 may perform the functions to be hereafter described as trusted computer functions that are trusted by the device's 100 operating system 140. In one embodiment, RoT 202 may perform functions to be hereafter described including: add a new actor function 210; a secure storage access function 212, including a key encapsulating key (KEK) regeneration function; an actor integrity measurement function 215; and an actor code update function 214. In order to implement these functions, RoT 202 may utilize nonces 220 and keys 222 (e.g., encrypted actor specific keys).

As will be described, RoT 202 may control access to data stored in secure storage 137 for each of the particular actors. For example Actor 1 160 may have a secure storage area 260, Actor 2 161 may have a secure storage area 261, and Actor N 163 may have a secure storage access area 263. Also, under the control of RoT 202, actors may have access to peripheral devices 232 (e.g., specialized processors 102, sensors 149, input devices 115, output devices 112, communication interfaces 130, etc.). Also, in one embodiment, a crypto block 230, such as a specialized cryptoprocessor, may be utilized by RoT 202 to implement key derivation functions, hash functions, and other specialized security functions.

As will be described, by utilizing RoT 202, exclusive and segregated access to application specific data for each of the actors 160, 161, 163 may be utilized in a shared storage area 137 such that the actor can retrieve and store data and may operate associated applications 145 in a secure manner. In other words, each actor (Actor 1, Actor 2 . . . Actor N) may have its own secure storage area 260, 261, 263, respectively. Also, each actor may have access to one or more of the peripheral devices 232, independently of the other actors. As has been described, each actor (e.g. Actor 1, Actor 2 . . . Actor N) may be a particular entity (e.g., a network company, utility company, commercial company, government institution, i.e., any entity) that utilizes device 100 with a particular application 145 to operate a particular function. By utilizing secure storage 137, having a secure storage area for each actor, each actor separately operating an application with device 100 is provided enhanced security. RoT 202 may be firmware executed by device 100 on power-up or upon exit from hibernation and may be executed by processor 102 in secure mode 105.

As should be appreciated, in order to be secure, storage of data in secure storage 137 (e.g., non-volatile memory (NVM)) should be encrypted and integrity checked. In order to achieve isolation, keys 222 used for encryption and integrity verification should be specific to the actor/owner of each data structure (e.g., Actor 1-N 160, 161, 163), so that data cannot leak across different actors sharing the device 100. Further, data should be released from secure storage 137 to the owning actor only, and only after the integrity of the actor has been verified, so that if the integrity of the actor has been compromised, the corrupted or hacked code will not be able to maliciously or accidentally leak sensitive stored data.

This may be achieved by each actor (e.g., Actor 1 160; Actor 2 161; Actor N 163) having their own individual secured data storage area (e.g. Actor 1 region 260, Actor 2 region 261, Actor N region 263). Further, device 100 operating RoT 202 may provide: a method to measure the integrity of an actor or to assess actor integrity measurements reported by third-parties (measure actor function 215); a method for the creation of actor specific secure storage keys (new actor function 210); a method to allow access to secure storage to an actor only if its integrity has been successfully verified (storage access function 212); and a method to allow access to secure storage for a specific actor across updates of the code for the actor (actor update function 214).

In one embodiment, device 100 may be utilized to authenticate an actor (160, 161, 163) that operates on the device autonomously as application 145 or an actor (160, 161, 163) external to the device that remotely operates through an application 145 locally executing on device 100; if the actor is authenticated, the device 100 allows access to data in secure storage 137 specific to that actor. Device 100 may include secure storage 137 and processor 102. Processor 102 may be coupled to secure storage 137 and may be configured to: obtain a nonce 220; obtain an actor signed hash for an actor; and apply a key derivation function utilizing the actor signed hash and the nonce as inputs to create an actor specific key encapsulating key (KEK). As one example, processor 102 may operate in a secure mode 105 and may be configured to: compute and sign or receive a signed hash for the actor computed by a trusted third party 170; choose or receive from a trusted party 170 a nonce 220 used for verification of the integrity for the actor; and apply a key derivation function utilizing the computed or received actor signed hash for the actor and the chosen or received nonce for the actor as inputs to create an actor specific key encapsulation key (KEK). For example, processor 102 may implement RoT 202 to implement these functions. Further, processor 102 (e.g., by implementing RoT 202) may command the creation and storing in the secure storage 137 for the particular actor of an actor specific key used to encrypt and integrity check the storage for the actor (e.g., Actor 1 specific storage area 260, Actor 2 specific storage area 261 . . . Actor N specific storage area 263); the actor specific key may be chosen once completely at random and may be stored encrypted and integrity verified using the actor specific KEK. Further, to unlock encrypted data for an actor, processor 102 implementing RoT 202 may next: use the received or computed actor signed hash together with the received or chosen nonce 220 as inputs to the key derivation function to recreate the actor specific KEK and use it to decrypt and integrity check the stored actor specific key, and, in case of successful integrity check result, use the decrypted actor specific key to decrypt and integrity check the actor specific secure storage 137 (e.g., data for Actor 1 160 from Actor 1 specific storage area 260). Further, it should be appreciated that access to encrypted data of secure storage includes such functionality as reading, writing, updating, etc., as per the application of the actor.

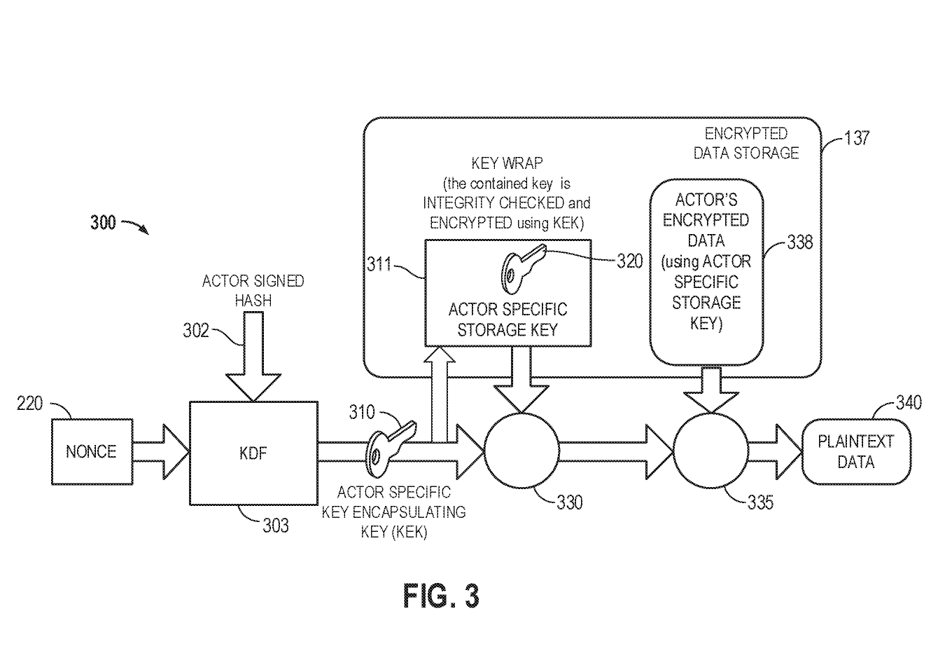

With additional reference to FIG. 3, a process 300 for adding a new actor 160 will be described. As one example, RoT 202 may implement a new actor function 210. To begin with, RoT 202 receives the code of an application 145 for a new actor 160. A nonce 220 is chosen by RoT 202. In one embodiment, the nonce 220 is at least one of a random number and/or a unique chip identifier for the RoT 202. RoT 202 computes a hash of the actor's application 145 code and of the nonce 220. Further, using a private key 222, RoT 202 signs the hash creating an actor signed hash 302. The private key 222 is known only to the RoT 202 and the disclosure of the private key is considered reasonably impossible. The nonce 220 and the actor signed hash 302 may be stored in the secure storage 137 for future reference. Further, an actor specific storage key 320 is created by RoT 202. Next, an actor specific key encapsulating key (KEK) is created. The actor specific KEK 310 is created by applying a key derivation function (KDF) 303 to the actor signed hash 302 and the nonce 220. The actor specific storage key 320 is wrapped (for example encrypted and integrity checked) with the actor specific KEK 310 and the resulting wrap 311 is stored in the secure storage 137. In this way, the actor specific storage key 320 may be stored and encrypted using the wrapping key (e.g., actor specific KEK 310).

Therefore, in one embodiment, RoT 202 may implement KDF 303, in which KDF 303 receives the actor's signed hash 302 and the actor's nonce 220. Based upon the received actor's signed hash 302 and nonce 220 for the new actor as inputs, KDF 303 creates an actor specific key encapsulating key (KEK) 310. The actor specific KEK 310 wraps the actor specific storage key 320 and the resulting wrap 311 is stored in secure storage 137 for the new particular actor (e.g. Actor 1 separate secure storage space 260, Actor 2 separate secure storage space 261, Actor N separate secure storage space 263, etc.). Also, it should be appreciated that after the new actor is added, data may be encrypted and stored as encrypted data 338 for the particular actor in the secure storage area for the actor (e.g. Actor 1 separate secure storage space 260, Actor 2 separate secure storage space 261, Actor N separate secure storage space 263, etc.) Thus, once the new actor has been added and/or after a reboot, encrypted data 338 may be accessed.

As an example, in order to extract the actor specific storage key 320, the actor specific KEK is recreated as a subsequent actor specific KEK 310. This occurs by the actor signed hash 302 together with the nonce 220 being reapplied to the KDF 303 such that the KDF 303 is applied. The output of the KDF 303 is a subsequent actor specific KEK 310 that, if accurate, unlocks at unlocking function 330 the application specific storage key 320 for the actor. In particular, unlocking function 330 may use the subsequent actor specific KEK 310 and use it to unlock/unwrap the 311 wrap and integrity check the resulting unwrapped actor specific storage key 320 (i.e. the actor specific storage key that had been encrypted and integrity checked by the actor specific KEK 310): if the integrity of the decrypted actor specific storage key is not successfully confirmed, and thus storage key unwrapping/unlocking fails, then the process may be terminated. At decryption functional block 335, the actor specific storage key 320 may be utilized to unlock/decrypt encrypted data 338 from the secure storage 137 such that decrypted data 340 may be utilized by applications for the requesting actor. It should be appreciated that the encrypted data 338 is particular for the requesting actor is stored specifically in a specific storage area of the secure storage 137 for the actor (e.g. Actor 1 separate secure storage space 260, Actor 2 separate secure storage space 261, Actor N separate secure storage space 263, etc.). Further, it should be appreciated that access to encrypted data and decryption of that data for usage by the actor application includes such functionality as reading, writing, updating, etc.

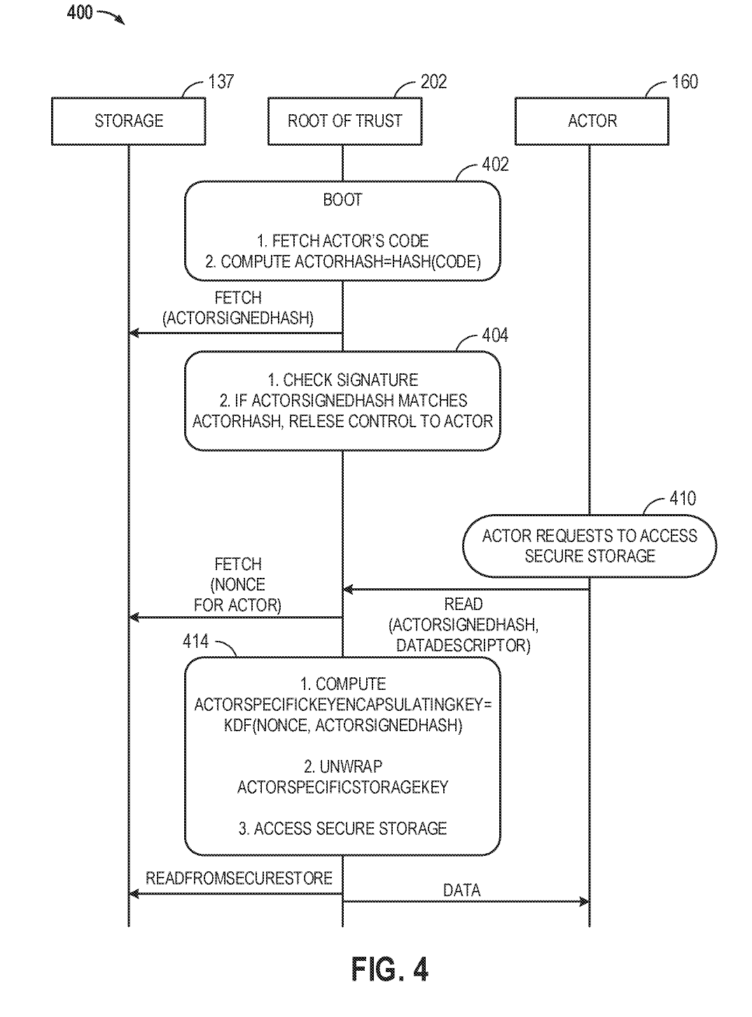

With reference to FIG. 4, a process 400 to allow an actor 160 to access stored encrypted data will be described. As one example, RoT 202 may implement a storage access function 212. However, before control is released to an actor 160 to access encrypted data, the integrity of the requesting actor must be verified through actor measurement function 215. For example, at boot-up, at block 402, the RoT 202 may recalculate the hash of an actor's application 145 before activating it (i.e. before starting to execute code of the application, providing to it startup input parameters hereafter referenced to as input parameters or input tokens). RoT 202 may fetch the previous actor's signed hash from secure storage 137. Next, a block 404, RoT 202 may check the signature. In particular, if the actor's previous signed hash matches the actor's hash (i.e., the signature is valid), then control may be released to application 145, thus activating actor 160. The RoT 202 may provide the signed hash 302 as one of the input tokens to the application 145, to be opaquely used by the application 145 as a token to be returned to the RoT when requesting access to the data in secure storage (hereafter referenced to as “application specific secure storage access token”). On the other hand, if the actor's signed hash does not match the actor's hash (i.e., the signature is not valid), the process may be terminated and control not released to the application. If, even in case of hash mismatch, control is nevertheless released to the 145 application, the RoT 202 may release this time, as application specific secure storage access token, the computed hash and not the reference signed hash 302.

At block 410, actor 160 requests access to secure storage 137, providing the application specific secure storage access token that was assigned to it by RoT 202 upon activation. RoT 202 may read the provided secure storage access token and the data description request. Further, RoT 202 may fetch the nonce 220 for the actor from secure storage 137. Based upon this, at block 414, RoT 202 may try to regenerate the application specific key encapsulating key (KEK) 310 applying the KDF 303 to the nonce 220 and the provided token. As previously described, the subsequent re-computed actor specific KEK 310 is then used to attempt to unwrap the actor specific storage key 320 from the actor specific key wrap 311 and the integrity of the decrypted actor specific storage key 320 is verified. If the integrity check fails, and thus unwrapping/unlocking fails, then the process may be terminated. In case of successful unwrapping, the unwrapped actor specific storage key 320 may then be used to decrypt encrypted data 338 (e.g., read data) for the particular actor from the particular memory area of secure storage 137 for the actor (e.g. specific memory area for Actor 1 260) such that that decrypted data may be utilized by the actor 160. It should be appreciated that access to encrypted data and decryption of that data for usage by the actor application includes such functionality as reading, writing, updating, etc.

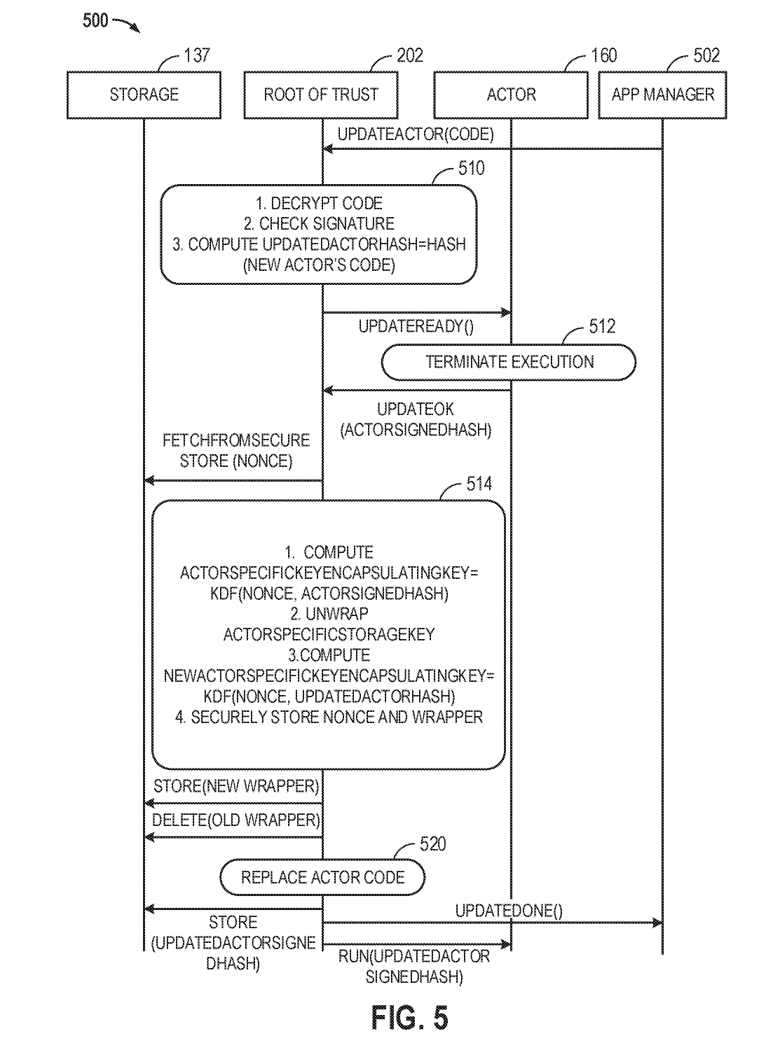

With reference FIG. 5, if the actor's code needs to be updated, an actor code update process 500 may be implemented. As one example, RoT 202 may implement an actor update function 214 which may provide an updated actor signed hash and a new actor specific KEK. As an example, an application manager 502 for the actor 160 may provide an updated actor application 145 code to RoT 202. RoT 202 may decrypt the actor application 145, check the signature, and compute an updated actor hash (e.g., hash(new actor's code, nonce), reusing nonce 220 or choosing a new nonce) (block 510). Further, the actor code update process 500 invokes functionality to notify the actor that a code update is taking place such that actor 160 terminates execution (Block 512). Actor 160 suspends operation and allows the RoT 202 to unlock the actor signed hash, the nonce, the actor specific storage key, and to use the updated actor signed hash in the generation of a new actor specific KEK.

At block 514, RoT 202, first computes the actor specific KEK based upon the KDF of the nonce and the actor signed hash. The nonce being fetched from secure storage 137. Further, based upon this, RoT 202 unwraps the actor specific storage key 320, as previously described. Next, RoT 202 computes the new actor specific KEK based upon the KDF of the nonce and the updated actor signed hash. Moreover, RoT 202 securely stores the nonce and the new wrapper 311 and deletes the old wrapper (old actor specific). RoT 202 then replaces the application 145 actor code (block 520) and stores the new updated actor signed hash 302 in secure storage 137. Also, RoT 202 updates the application manager 502 that the update is done and functions can be run with the new updated actor.

Thereafter, the RoT activates the new actor's application code 145, providing the new signed hash 302 as an application specific secure storage access token. It should be appreciated that only the KEK, optionally the nonce and the actor signed hash are changed in this process, whereas the actor specific storage key 320 protecting the data and the data 338 itself is not affected at all by the process.

According to the embodiments previously set forth, the actor's signed hash is used as token to authenticate the actor (against process impersonation/escalation of privilege attacks) to access secure storage 137. Additionally, the actor's signed hash becomes a mathematical input to the KDF to release the actor specific storage key 320. Further, secure storage 137 access is restricted to the specific data-set actor/owner 160 only (i.e., the actor signed hash is known only to the actor 160 and the subset of RoT 202 functions dealing with secure storage 137). If the actor leaks the actor signed hash, it cannot be used to unlock equivalent instances on other devices/chips because other secrets owned by the RoT 202 are involved in the key derivation function (e.g., the nonce). The actor signed hash is used as a token to release the actor specific storage key 320 protecting the secure storage 137 and, as such, handover between a previous and later version of the same actor is managed without having to re-encode the data (only the actor specific key encapsulating the key (KEK) 310 is updated, not the actor specific storage key itself). During the update process, the actor 160 actively acknowledges the update and consents to losing control of its data until the update is complete (i.e., after acknowledgment that the key encrypting data is protected using an updated actor signed hash—instead of the original hash—and only the updated actor signed hash is able to unlock it). Alternatively, to deal with botched updates, both wrappers could be maintained in the system, until the updated actor takes successfully over. It should be appreciated that if the actor's code is compromised, the actor signed hash will not match the stored one and, as such, release of encrypted data 338 from the secure storage 137 becomes impossible.

It should be appreciated that aspects of the previously described processes may be implemented in conjunction with the execution of instructions by a processor (e.g., processor 102) of devices (e.g., device 100), as previously described. Particularly, circuitry of the devices, including but not limited to processors, may operate under the control of a program, routine, or the execution of instructions to execute methods or processes in accordance with embodiments described (e.g., the processes and functions of FIGS. 2-5). For example, such a program may be implemented in firmware or software (e.g. stored in memory and/or other locations) and may be implemented by processors and/or other circuitry of the devices. Further, it should be appreciated that the terms device, SoC, processor, microprocessor, circuitry, controller, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., communication subsystems / interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a secure processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A device comprising:
a storage; and
a processor coupled to the storage, the processor configured to:
obtain a nonce;
obtain an actor signed hash for an actor;
apply a key derivation function utilizing the actor signed hash and the nonce as inputs to create an actor specific key encapsulating key (KEK).

2. The device of claim 1, wherein, the processor is further configured to:
generate a subsequent actor specific KEK; and
unwrap an actor specific storage key utilizing the subsequent actor specific KEK.

3. The device of claim 2, wherein, the processor is further configured to decrypt encrypted data from the storage utilizing the actor specific storage key.

4. The device of claim 1, wherein, the processor is further configured to implement a root of trust (RoT), wherein, the RoT securely stores the nonce and an actor specific storage key in the storage.

5. The device of claim 4, wherein, the nonce is at least one of a random number and/or a unique chip identifier for the RoT.

6. The device of claim 4, wherein, the RoT applies the key derivation function to generate the actor specific KEK.

7. The device of claim 6, wherein, the actor specific KEK is used to wrap the actor specific storage key.

8. The device of claim 7, wherein, the wrap is created for encrypting and integrity checking the actor specific storage key with the actor specific KEK.

9. The device of claim 6, wherein, to update an actor's actor specific KEK, the RoT computes an updated actor signed hash and applies the key derivation function to the updated actor signed hash to generate a new actor specific KEK.

10. A method to authenticate an actor comprising:
obtaining a nonce;
obtaining an actor signed hash for an actor; and
applying a key derivation function utilizing the actor signed hash and the nonce as inputs to create an actor specific key encapsulating key (KEK).

11. The method of claim 10, further comprising:
generating a subsequent actor specific KEK; and
unwrapping an actor specific storage key utilizing the subsequent actor specific KEK.

12. The method of claim 11, further comprising decrypting encrypted data utilizing the actor specific storage key.

13. The method of claim 10, further comprising implementing a root of trust (RoT), wherein, the RoT securely stores the nonce and an actor specific storage key in a storage.

14. The method of claim 13, wherein, the nonce is at least one of a random number and/or a unique chip identifier for the RoT.

15. The method of claim 13, wherein, the RoT applies the key derivation function to generate the actor specific KEK.

16. The method of claim 15, wherein, the RoT applies the actor specific KEK to encrypt and integrity check the actor specific storage key.

17. The method of claim 15, wherein, to update an actor's actor specific KEK, the RoT computes an updated actor signed hash and applies the key derivation function to the updated actor signed hash to generate a new actor specific KEK.

18. A non-transitory computer-readable medium including code that, when executed by a processor operating in a secure mode of a device, causes the processor to:
obtain a nonce;
obtain an actor signed hash for an actor; and
apply a key derivation function utilizing the actor signed hash and the nonce as inputs to create an actor specific key encapsulating key (KEK).

19. The computer-readable medium of claim 18, further comprising code to:
generate a subsequent actor specific KEK; and
using the subsequent actor specific KEK, unwrapping an actor specific storage key.

20. The computer-readable medium of claim 19, further comprising code to decrypt encrypted data utilizing the actor specific storage key.

21. The computer-readable medium of claim 18, further comprising code to implement a root of trust (RoT), wherein, the RoT securely stores the nonce and an actor specific storage key.

22. The computer-readable medium of claim 21, wherein, the nonce is at least one of a random number and/or a unique chip identifier for the RoT.

23. The computer-readable medium of claim 21, wherein, the RoT applies the key derivation function to generate the actor specific KEK.

24. The computer-readable medium of claim 23, wherein, the RoT applies the actor specific KEK to encrypt and integrity check the actor specific storage key.

25. The computer-readable medium of claim 23, wherein, to update an actor's actor specific KEK, the RoT computes an updated actor signed hash and applies the key derivation function to the updated actor signed hash to generate a new actor specific KEK.

26. A device comprising:
means for obtaining a nonce;
means for obtaining an actor signed hash for an actor; and
means for applying a key derivation function utilizing the actor signed hash and the nonce as inputs to create an actor specific key encapsulating key (KEK).

27. The device of claim 26, further comprising:
means for generating a subsequent actor specific KEK; and
means for using the subsequent actor specific KEK to unwrap an actor specific storage key.

28. The device of claim 27, further comprising means for decrypting encrypted data utilizing the actor specific storage key.

29. The device of claim 28, further comprising means for implementing a root of trust (RoT), wherein, the RoT securely stores the nonce and an actor specific storage key.
